(19) United States
(12) Patent Application Publication
(10) Pub. No.: US 2006/0286970 A1
(43) Pub. Date: Dec. 21, 2006

(54) Telephone apparatus for displaying local time of the other end of communication method therefor, and program

(75) Inventors: Etsuo Otobe, Kyoto (JP); Mitsunobu Sakai, Osaka (JP); Hirokazu Ozaki, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Sanyo Electric Co., Ltd., Moriguchi-shi (JP)

(21) Appl. No.: 10/564,361

(22) PCT Filed: Jul. 16, 2004
(86) PCT No.: PCT/JP04/10567

§ 371 Date: Jul. 21, 2006

(30) Foreign Application Priority Data
Jul. 16, 2003 (JP) 2003-275444

(51) Int. Cl. H04M 15/06; H04M 3/42

(52) U.S. Cl. 455/415; 379/142.01

(57) ABSTRACT

A telephone stores information indicating a region in which a callee is currently situated in a region code column (112) of a personal information table (110), calculates the local time of the region indicated by the region information, and displays the calculated local time, thus enabling the local time of the region in which the callee is currently situated to be properly displayed. The region information is updatable in accordance with a user operation or a current region notification from the callee, and if updated in accordance with the movements of the callee, the local time of the region in which the callee is currently situation can always be correctly displayed.

### TECHNICAL FIELD

The present invention relates to telephones, and particularly to technology for displaying the local time at the other end of the connection.

### BACKGROUND ART

These days, international telephone rates are becoming cheaper, providing most people with the opportunity to freely make international calls.

While telephone manners dictate that it is preferable to avoid making non-urgent calls late at night or during mealtimes, this requires a caller placing an international call to an area in a different time zone to make a judgment based on the local time at the other end of the connection.

There exist conventional telephones designed to facilitate this process that use the country code included in the telephone number, or a combination of the country code and the area code which follows the country code, to deduce the local time at the other end of the connection prior to making the call, and furnish the caller with the deduced time (e.g. see Japanese Published Patent Application No. 2002-171334).

However, a problem with these conventional telephones is that they are unable to properly display the local time at the other end if the telephone being called is a mobile telephone equipped with an international roaming function, for example.

Mobile telephones equipped with an international roaming function can be called using the same telephone number as that used domestically, merely by being connected to a local communication system in the area to which the user moves. For this reason, there is no way of working out from the telephone number where the mobile telephone (i.e. the local time) is currently being used.

### DISCLOSURE OF THE INVENTION

In view of the above problem, the present invention aims to provide a telephone capable of properly providing a caller with the local time at the other end of the connection, when the callee's telephone does not give any clues for deducing the local time from the telephone number, as is the case with mobile telephones equipped with an international roaming function, for example, and to provide related methods.

To resolve the above problem, a telephone of the present invention is for displaying a local time of a locality of a callee, and includes an acquiring unit operable to acquire region information relating to the locality of the callee, a calculating unit operable to calculate the local time using the region information, and a display unit operable to display the local time.

According to this structure, it is possible, by acquiring region information, to find out the callee's locality even if the telephone number of the callee's telephone does not include information relating to the locality, and thus to correctly calculate and display the local time.

Also, the telephone may further include a storage unit operable to store the acquired region information, and the calculating unit may calculate the local time using the region information stored in the storage unit.

Since the region information according to this structure does not need to be inputted every time the local time is displayed, the time and effort required by the user can be greatly reduced in the case of the user inputting the region information manually, for example. By updating the region information only when the callee shifts time zones, the user is always able to obtain the correct local time of the callee.

Also, the region information may be transmitted from a telephone of the callee represented by a modulation signal in an audible frequency band, and the acquiring unit may receive the modulation signal and acquire the region information by decoding the received modulation signal.

Alternatively, the region information may be transmitted from a telephone of the callee represented by an electronic mail, and the acquiring unit may acquire the region information by receiving the email.

Since the region information according to these structures is acquired from the callee's telephone, the user is not required to input the region information manually. Since region information represented by a modulation signal can be acquired through an audio line, it is possible to acquire region information even from mobile telephones in regions where a data line cannot be used. Furthermore, region information represented by an email is ideal when the region information is acquired from a mobile telephone in a different time zone.

Also, the region information may be recorded in a location register that manages a movement of the telephone of the callee in a telephone network, and the acquiring unit may acquire the region information from the location register via the telephone network.

Also, the acquiring unit may acquire the region information as a reply to a callout to the telephone of the callee, and the telephone may further include a reception unit operable to receive a user operation after the display of the local time, the operation being one of approving and canceling a call, and an instructing unit operable to instruct the telephone network to one of approve and cancel the call, upon receipt of the user operation.

Since the region information according to these structures is acquired from a location register, the user is not required to input the region information manually. Since region information expressing the latest locality of the callee is managed in the location register in connection with the location registration of the mobile telephone, the correct local time is always displayed by using the region information.

In particular, if the telephone network is configured to notify the region information to the telephone in response to a callout to the callee and to place a call to the callee's telephone after receiving an instruction approving the call, the user can determine whether or not to make the call based on the latest local time displayed after dialing.

A telephone of the present invention is for use in a plurality of time zones, and includes an acquiring unit operable to acquire region information relating to a locality of the telephone, and a notifying unit operable to notify the acquired region information to another telephone.

Also, the notifying unit may perform the notification by transmitting the region information to the other telephone represented by a modulation signal in an audible frequency band.

Alternatively, the notifying unit may perform the notification by transmitting the region information to the other telephone represented by an email.

By notifying its locality to the other telephone, the telephone is, according to these structures, able to have the other telephone correctly display the local time at the locality of the telephone. Also, the above-mentioned effects are obtained as a result of transmitting the region information represented by a modulation signal or an email.

A telephone network of the present invention is for managing a movement of a telephone, and includes a location registration unit operable to record region information relating to a locality of the telephone, a reception unit operable to receive from another telephone, specification information specifying the telephone, and a notifying unit operable to notify the region information to the other telephone, upon receipt of the specification information.

Also, the reception unit may receive the specification information as a callout request to the telephone, and the telephone network may further include a waiting unit operable to wait for an instruction from the other telephone after the notification of the region information, the instruction being one of approving and canceling a call, and a call unit operable to call the telephone if the instruction approving the call is received or if a predetermined time period elapses without receiving the instruction canceling the call.

According to these structures, the local time at the locality of the telephone can be correctly displayed on another telephone as a result of the telephone network notifying the locality to the other telephone. Since the telephone network is able to provide the latest region information obtained as a result of the location registration, the other telephone is always able to display the correct local time based on the region information. Also, the effects described above are obtained by placing a call to the callee after receiving approval from the other telephone.

A telephone system of the present invention includes a first telephone for use in a plurality of time zones, and a second telephone for displaying a local time of a locality of the first telephone. The first telephone includes a first acquiring unit operable to acquire region information relating to a locality of the first telephone, and a notifying unit operable to notify the region information to the second telephone. The second telephone includes a second acquiring unit operable to acquire the region information from the first telephone, a calculating unit operable to calculate the local time using the region information, and a display unit operable to display the local time.

A telephone system of the present invention includes a telephone network for managing a movement of a first telephone, and a second telephone for displaying a local time of a locality of the first telephone. The telephone network includes a location registration unit operable to record region information relating to the locality of the first telephone, a reception unit operable to receive from the second telephone, specification information specifying the first telephone, and a notifying unit operable to notify the region information to the second telephone, upon receipt of the specification information. The second telephone includes an acquiring unit operable to acquire the region information from the telephone network, a calculating unit operable to calculate the local time using the region information, and a display unit operable to display the local time.

Also, the reception unit may receive the specification information as a callout request to the first telephone, and the telephone network may further include a waiting unit operable to wait for an instruction from the second telephone after the notification of the region information, the instruction being one of approving and canceling a call, and a call unit operable to call the first telephone if the instruction approving the call is received or if a predetermined time period elapses without receiving the instruction canceling the call.

According to these structures, the effects described above are obtained in the telephone system.

A method of the present invention is a display method for displaying a local time of a callee performed in a telephone, and includes the steps of acquiring region information relating to a locality of the callee, calculating the local time using the region information, and displaying the local time.

Also, the method may include the further step of storing the region information, and the local time may be calculated using the stored region information.

A method of the present invention is a notification method for notifying a locality performed in a telephone for use in a plurality of time zones, and includes the steps of acquiring region information relating to a locality of the telephone, and notifying the region information to another telephone.

A method of the present invention is a notification method for notifying a locality of a telephone performed in a telephone network that manages a movement of the telephone, and includes the steps of recording region information relating to the locality of the telephone, receiving from another telephone, specification information specifying the telephone, and notifying the region information to the other telephone, upon receipt of the specification information.

Also, the specification information may be received as a callout request to the telephone, and the method may include the further steps of waiting for an instruction from the other telephone after the notification of the region information, the instruction being one of approving and canceling a call, and calling the telephone if the instruction approving the call is received or a predetermined time period elapses without receiving the instruction canceling the call.

A method of the present invention is a display method for displaying a local time of a locality of a first telephone performed in a telephone system that includes the first telephone, which is for use in a plurality of time zones, and a second telephone. The method includes the steps of acquiring, in the first telephone, region information relating to the locality of the first telephone; notifying the region information from the first telephone to the second telephone; acquiring, in the second telephone, the region information from the first telephone; calculating, in the second telephone, the local time using the region information; and displaying, in the second telephone, the local time.

A method of the present invention is a display method for displaying a local time of a locality of a first telephone performed in a telephone system that includes a second telephone and a telephone network for managing a movement of the first telephone. The method includes the steps of recording, in the telephone network, region information relating to the locality of the first telephone; receiving, in the telephone network, specification information specifying the first telephone from the second telephone; notifying the region information from the telephone network to the second telephone, upon receipt of the specification information; acquiring, in the second telephone, the region information from the telephone network; calculating, in the second telephone, the local time using the region information; and displaying, in the second telephone, the local time.

Also, the specification information may be received as a callout request to the first telephone, and the method may include the further steps of waiting, in the telephone network, for an instruction from the second telephone after the notification of the region information, the instruction being one of approving and canceling a call; and calling, in the telephone network, the first telephone if the instruction approving the call is received or a predetermined time period elapses without receiving the instruction canceling the call.

A computer program of the present invention may be a machine-readable program for causing a computer to execute the steps included in any of the above methods.

The same effects as for the telephone are obtained with the methods and computer programs.

### BRIEF DESCRIPTION OF THE DRAWINGS

FIG. 1 is a functional block diagram showing the overall structure of a telephone of embodiment 1;

FIG. 2 is a front view showing an outward appearance of the telephone;

FIG. 3 shows an exemplary data structure and content of a personal information table;

FIG. 4 shows an exemplary data structure and content of a time zone information table;

FIG. 5 is a flowchart showing exemplary personal information update processing;

FIG. 6 shows an exemplary personal information update screen;

FIG. 7 shows an exemplary region selection screen;

FIG. 8 shows exemplary region information modulated to a DTMF signal;

FIG. 9 shows exemplary region information represented by an email;

FIG. 10 shows an exemplary telephone directory screen;

FIG. 11 is a flowchart showing exemplary local time display processing;

FIG. 12 shows an exemplary local time display pop-up;

FIG. 13 shows a variation of the data structure and content of a personal information table;

FIG. 14 is a flowchart showing a variation of the personal information update processing;

FIG. 15 shows a variation of the personal information update screen;

FIG. 16 is a schematic view showing the overall structure of a mobile telephone system in an embodiment 3;

FIG. 17 shows an example of the principal information managed by an HLR;

FIG. 18 is a flowchart showing a location registration procedure;

FIG. 19 shows exemplary correspondence information indicating the correspondence between location IDs and time zones;

FIG. 20 is a flowchart showing a procedure to originate a call, including display of the local time at the other end of the connection;

FIG. 21 shows an exemplary local time display screen; and

FIG. 22 is a flowchart showing a procedure for acquiring a location ID in response to a user operation.

### BEST MODE FOR CARRYING OUT THE INVENTION

### Embodiment 1

A telephone of embodiment 1 acquires region information relating to the locality of a callee, calculates the local time at the locality based on the acquired region information, and furnishes the user with the calculated local time. The telephone acquires the region information from the user or from the callee's telephone, and holds the acquired region information in association with the callee. Then, when the user calls the callee, for example, the telephone refers to the region information and furnishes the user with the local time of the callee's locality.

Furthermore, the telephone acquires the region information as a result of an operation performed at any time by the user, or from a notification sent from the callee's telephone, and updates the held region information with the acquired information.

The particular case considered here is when the callee's locality cannot be known directly from the telephone number due to the callee using a mobile telephone equipped with an international roaming function, for example. In order for the local time to be correctly displayed even in this case, the region information is here expressed independently of the callee's telephone number or a part thereof.

A telephone of embodiment 1 is described in detail below while referring to the drawings.

Overall Structure

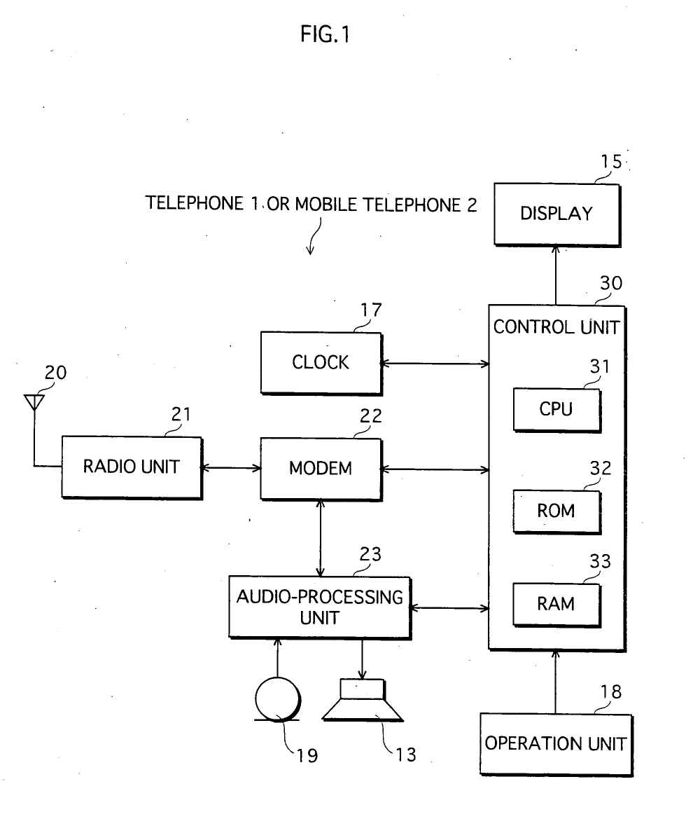

FIG. 1 is a functional block diagram showing the overall structure of a telephone 1 of embodiment 1. A mobile telephone is illustrated here by way of example.

Telephone 1, as shown in FIG. 1, is constituted from an antenna 20, a radio unit 21, a modem (modulator/demodulator) 22, an audio processor 23, a microphone 19, a receiver 13, a clock 17, an operation unit 18, a control unit 30, and a display 15.

Control unit 30 includes a CPU (central processing unit) 31, a ROM (read only memory) 32, and a RAM (random access memory) 33. Control unit 30 realizes different functions as a result of CPU 31 executing computer programs stored in ROM 32 using RAM 33 as working memory. These functions include controlling the general operation of telephone 1, together with the functions of acquiring region information and displaying local time, which are a feature of telephone 1. Also, RAM 33 permanently holds, as a result of having battery backup, different types of information until an update or delete operation is received from the user. This information includes personal information relating the callee (includes region information), and time zone information indicating the time zones of different regions and used in computing the local time.

Radio unit 21 amplifies signals received by antenna 20, and modem 22 demodulates the amplified signals into audio signals and data signals. Audio-processing unit 23 digital/analog (D/A) converts the audio signals and outputs the converted signals from receiver 13. Control unit 30 performs predetermined processing on the data signals (e.g. electronic mail processing).

Audio-processing unit 23 also analog/digital (A/D) converts audio signal acquired from microphone 19. Modem 22 modulates the A/D converted audio signals and data signals provided from control unit 30 for transmission, and radio unit 21 amplifies the modulated signals and transmits the amplified signals from antenna 20.

Since the actual structure for receiving/transmitting audio and data signal is not a feature of the present invention, it is simply noted here that a general structure conventionally used is employed as appropriate.

Clock 17 holds the current time at the locality of telephone 1, and outputs the current time to control unit 30.

Display 15, which is realized, for example, by a color LCD (liquid crystal display) panel, a DMD (digital mirror display), an organic EL (electroluminescent) display, or a PDP (plasma display panel), displays status information (e.g. remaining battery life, field strength, current time, etc), personal information (e.g. callee's name, telephone number, region information, etc), and the local time at the callee's locality, among other information.

Operation unit 18, which includes a numeric keypad, an off-hook key, an on-hook key, a cursor key and the like, receives user operations (dialing, call start, call end, etc), as well as personal information inputs, update operations, and the like.

Outward Appearance

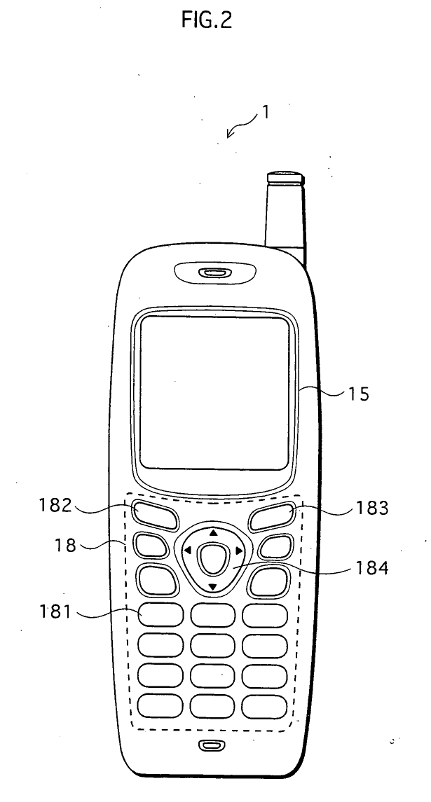

FIG. 2 is a front view showing the outward appearance of the telephone. The disposal of display 15 as well as a numeric keypad 181, an off-hook key 182, an on-hook key 183, and a cursor key 184 is illustrated in FIG. 2 by way of example.

Data Structure

Personal information and time zone information are held respectively as follows in a personal information table and a time zone information table provided in RAM 33.

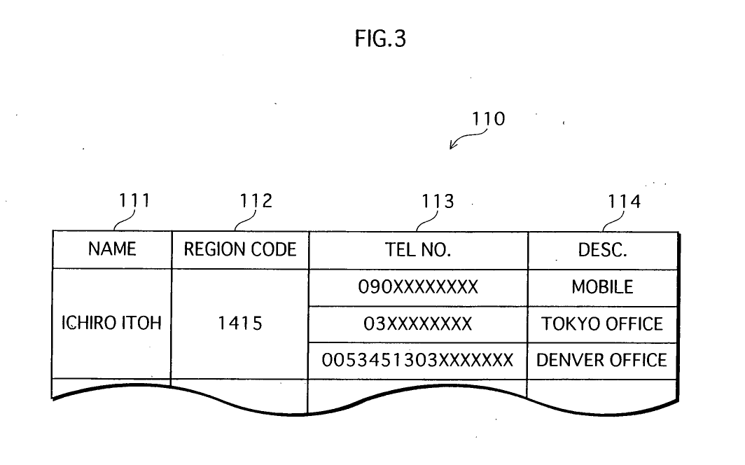

FIG. 3 shows an exemplary data structure and content of a personal information table 110.

In personal information table 110, a name column 111 holds callees' names, a region code column 112 holds region codes as region information corresponding to callees, a telephone number column 113 holds telephone numbers used to make calls to callees, and a description column 114 holds descriptions corresponding to telephone numbers. Every name has associated therewith a single region code as well as one or more telephone numbers and descriptions.

Note here that the region code indicates the locality of the corresponding callee independently of the callee's telephone number(s).

The content of personal information table 110 is inputted and updated via a personal information update screen (described below).

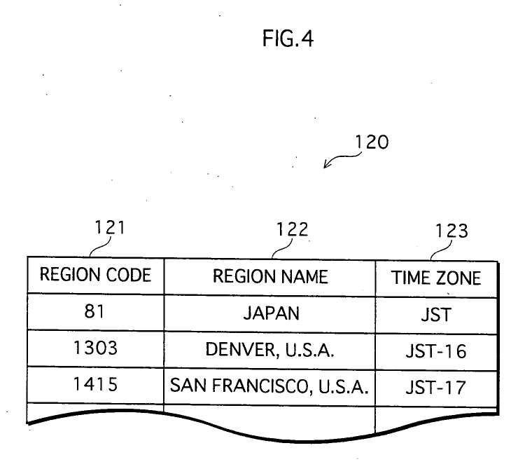

FIG. 4 shows an exemplary data structure and content of a time zone information table 120.

In time zone information table 120, a region code column 121 holds region codes identifying different regions, a region name column 122 holds the region names of the regions indicated by the region codes, and a time zone column 123 holds the time zones to which the regions identified by the region codes belong.

With a view to use in Japan, the time zones in the given example are expressed as a time difference with Japanese Standard Time (JST). Also, with a view to facilitating user familiarity, region codes are expressed by country codes and area codes used for fixed line telephones in the respective regions. This is merely a convenient example, and other display formats may of course be employed.

Personal Information Acquisition & Update Processing

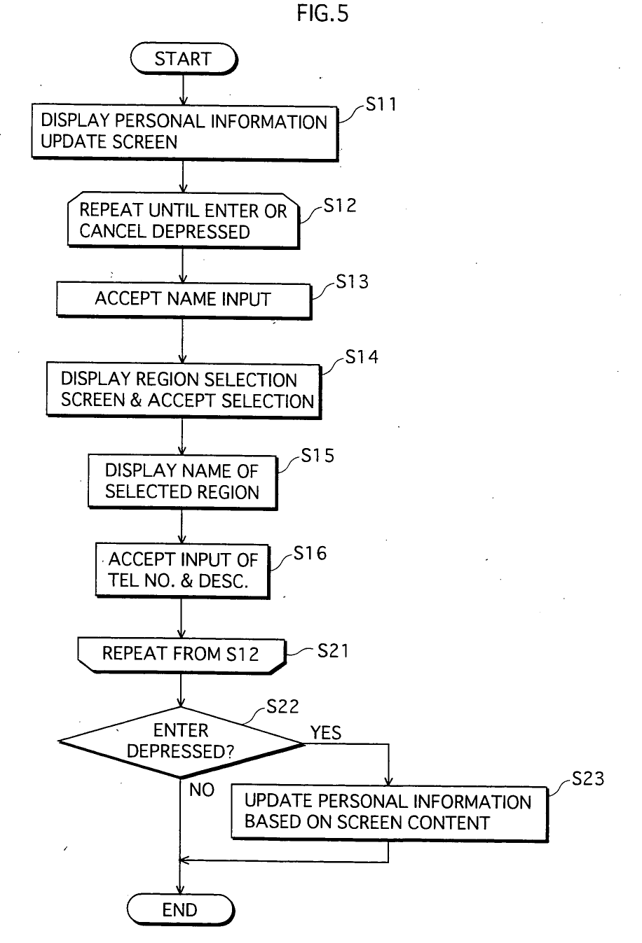

FIG. 5 is a flowchart showing personal information acquisition and update processing, according to which personal information inputted by the user is acquired and the personal information table is updated using the acquired information. This processing is activated on receipt of a predetermined user operation.

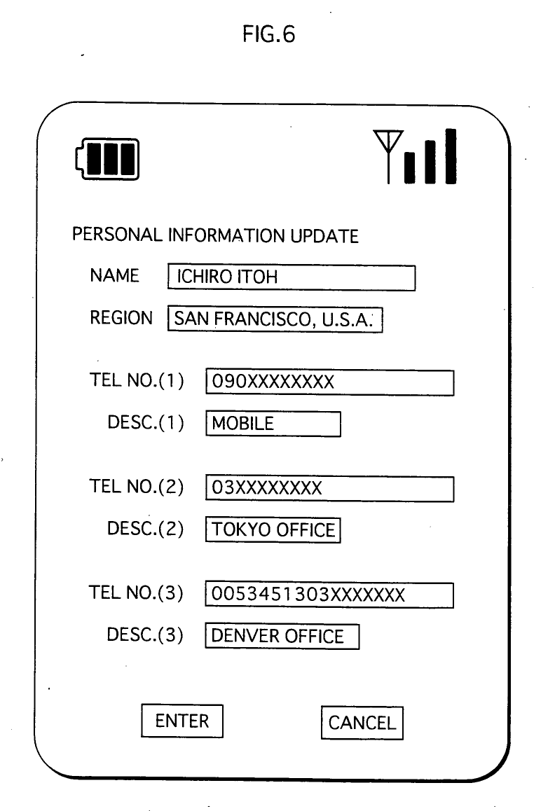

FIG. 6 shows an exemplary personal information update screen displayed by display 15 as part of the processing.

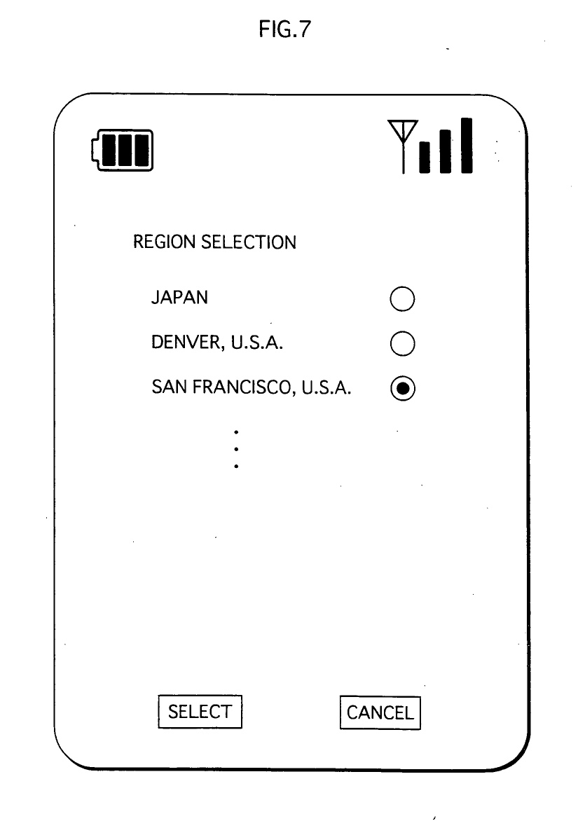

FIG. 7 shows an exemplary region selection screen displayed by display 15 as part of the processing.

When the personal information acquisition and update processing is activated, control unit 30 refers to one person's worth of personal information in personal information table 110, and displays the personal information update screen (FIG. 6) together with the personal information referred to (S11). Operation unit 18 then accepts inputs to the different fields until either the enter key or cancel key (e.g. allocated respectively to off-hook key 182 and on-hook key 183) is depressed (S12-S21).

Firstly, operation unit 18 accepts input to the name field (S13). Next, control unit 30 displays the region selection screen (FIG. 7) showing the region names held in time zone information table 120, and accepts a user selection of one region (S14). On receipt the selection, control unit 30 again displays the personal information update screen, and displays the selected region in the region field (S15). Operation unit 18 then accepts input to the telephone number and description fields (S16).

When the loop processing is ended by the depressing of the enter key (S22=YES), the personal information table is updated in accordance with the content of the personal information update screen (S23).

Note that the personal information acquisition and update processing may be executed sequentially for personal information relating to a plurality of callees, in accordance with cursor key operations or the like carried out by the user with respect to a telephone directory screen (not depicted), for example.

Variation: Data Acquisition from the Callee's Telephone

A variation of the personal information acquisition and update processing involves acquiring the above personal information (in particular, region information) from the callee's telephone. In this case, the callee's telephone transmits region information indicating its telephone number and locality to telephone 1 represented in a machine recognizable format. Telephone 1 receives the region information and updates the personal information table in accordance with the received information.

The region information may be represented by a modulation signal in an audible frequency band (e.g. dual-tone multi-frequency or “DTMF” signal).

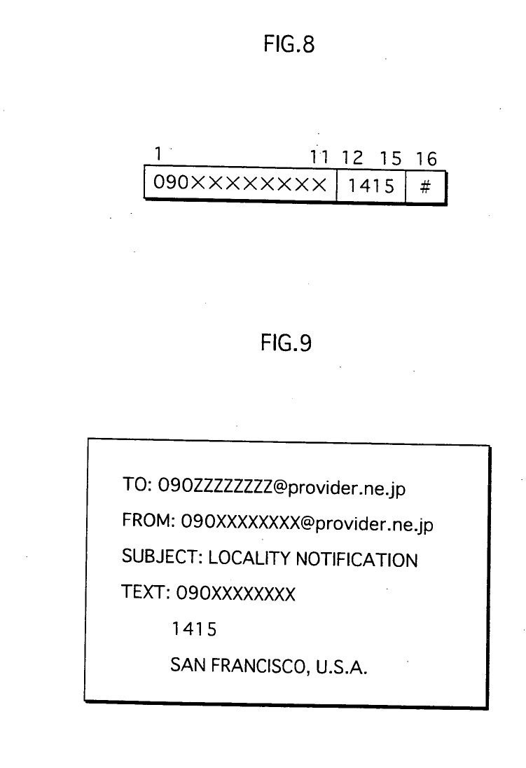

FIG. 8 shows an exemplary format of region information encoded to a DTMF signal. In the given example, each telephone number has an 11-diget fixed length, and each region code is of variable length and ends with a hash “#” sign.

The callee's telephone transmits a DTMF signal representing region information through an audio channel either immediately after the audio channel is established or at some point during the call, in response to an operation by the callee.

The DTMF signal received by telephone 1 is passed from audio-processing unit 23 to control unit 30, and decoded by control unit 30 to obtain a telephone number and a region code. Control unit 30 searches personal information table 110 for a callee corresponding to the obtained telephone number, and, using the obtained region code, updates the entry in region code column 112 corresponding to the received callee.

Note that control unit 30 should decode the DTMF signal either immediately after the audio channel is established or at some point during the call, in response to a user operation. Also, sound output from receiver 13 may be inhibited during the decoding so as to make the DTMF signal inaudible to the user.

Region information can be transmitted/received by electronic mail (hereinafter, simply “email”) if both telephone 1 and the callee's mobile telephone are able to use email services.

FIG. 9 shows exemplary region information represented by an email. The email in the given example consists of a specific subject showing that the email relates to region information, and a main text body that includes a telephone number, a region code and a region name.

When telephone 1 receives an email such as this, control unit 30 identifies from the subject that it relates to region information, and extracts the telephone number, region code and region name from the text body. Then, using the extracted telephone number and region code, control unit 30 updates the corresponding entry in region code column 112 of personal information table 110 in the same way as with the DTMF signal.

Note that the region name is information added for the user's comprehensibility, and is not actually used in the personal information acquisition and update processing performed by telephone 1.

Local Time Display Processing

Telephone 1 displays the local time of the callee's locality based on corresponding region information. Telephone 1 receives the user's selection of the callee's locality via a telephone directory screen, for example, and displays the local time of the selected locality.

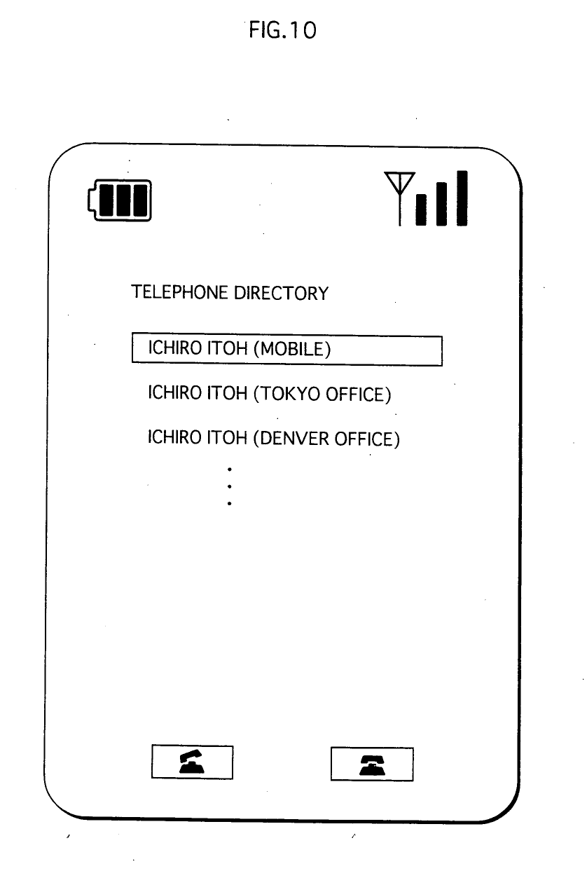

FIG. 10 shows an exemplary telephone directory screen displayed by display 15. On this screen is displayed, specifically, the names of callees corresponding to the individual telephone numbers held in the personal information table (see FIG. 3), as well as the corresponding descriptions. This screen may be configured as a search result screen that focuses on specific callees (e.g. those whose name starts with “I”) in response to search instructions from the user.

This kind of search is often conducted when calling someone. The user moves the cursor sequentially over the callees displayed on the telephone directory screen by operating cursor key 184, for example, and depresses off-hook key 182 when the cursor reaches the desired callee, after which telephone 1 then dials the telephone number of the selected callee. Here, the callee marked by the cursor is displayed in a manner that allows a visual distinction to be made with the other callees, by means of inverse display, flashing display, different colored display, or the like. In FIG. 10 the caller marked by the cursor is enclosed within a rectangular box.

Here, the local time display processing may, for example, be activated after the cursor remains over a particular callee for a certain period of time.

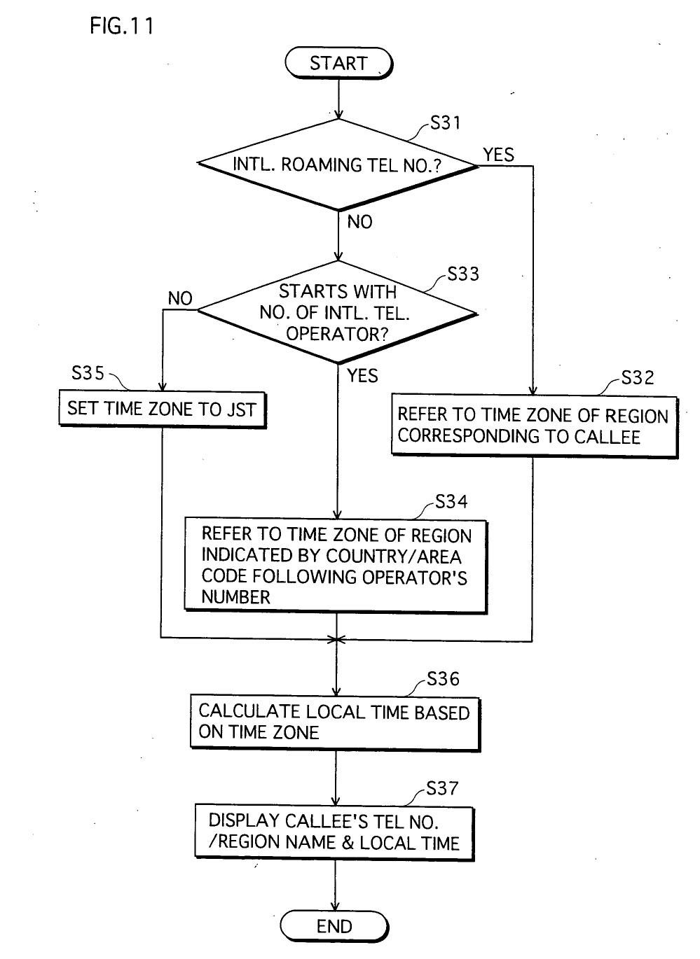

FIG. 11 is a flowchart showing local time display processing.

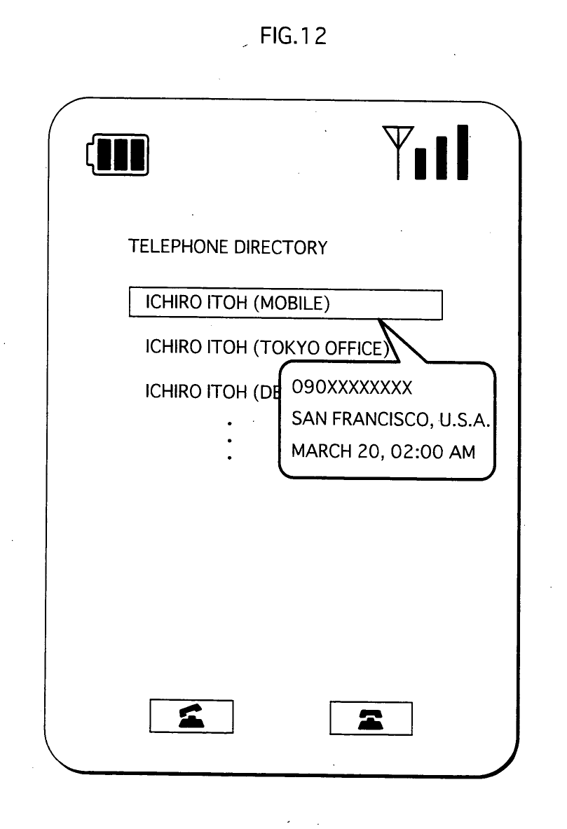

FIG. 12 shows an exemplary local time display pop-up displayed over the telephone directory screen in this processing.

When the local time display processing is activated, control unit 30 judges whether the telephone number of the callee marked by the cursor starts with a number that enables international roaming (e.g. “090”). If judged to start with a number that enables international roaming (S31=YES), control unit 30 refers to the callee's region code held in region code column 112, and refers to the time zone of the region indicated by the callee's region code in time zone information table 120 (S32).

If judged to not start with a number that enables international roaming (S31=NO), control unit 30 judges whether the telephone number starts with the number of an international telephone operator (e.g. “005345”) not employing international roaming. If judged to start with the number of an international telephone operator (S33=YES), control unit 30 refers to the time zone corresponding to the region code following the operator's call number in time zone information table 120 (S34).

If judged to not start with the number of an international telephone operator (S33=NO), control unit 30 sets the time zone to Japan (JST+0) at step S35.

In all of the above cases, control unit 30 then calculates the local time by adding the time difference shown by the time zone to the current time acquired from clock 17 (S36), and displays the telephone number, region name, and calculated local time in a local time display pop-up (S37).

Note that local time display processing may, of course, be performed using an incoming-call history screen or an outgoing-call history screen, rather than the telephone directory screen. The telephone numbers remaining on incoming-call and outgoing-call history screens are, however, not necessarily held in personal information table 110. Thus, when the need arises to display the local time relating to a telephone number not being held in personal information table 110, either “local time unknown” or simply the current time acquired from clock 17 may be displayed.

### Embodiment 2

A mobile telephone of embodiment 2 is for use in a plurality of different time zones. This type of mobile telephone includes those equipped with an international roaming function.

The mobile telephone receives a user specification of the mobile telephone's locality, and notifies the received locality to a telephone as described in embodiment 1.

The telephone of embodiment 2 is described in detail below, while referring to the drawings.

Overall Structure

Mobile telephone 2 of embodiment 2, which is realized using a configuration similar to telephone 1 shown in embodiment 1, is described again here with reference to FIG. 1.

Since the structure for realizing the actual international roaming function in mobile telephone 2 is not a feature of the present invention, and also since mobile telephones having such a function are already in general use, related description is omitted here.

In a control unit 30 of mobile telephone 2, a ROM 30 holds computer programs for performing locality reception processing and locality notification processing, and a CPU 31 executes these processing operations.

Locality Reception Processing

Mobile telephone 2 receives user specification of localities at any time. The locality specification is narrow enough to at least enable identification of a single time zone (i.e. the country and respective region therein in the case of countries having a plurality of time zones).

Mobile telephone 2 holds time zone information in a time zone information table 120 the same as telephone 1. Control unit 30 displays various region names held in table 120 on a region selection screen (see FIG. 7) in response to a predetermined user operation, receives specification of one region from the user, and stores the corresponding region code in RAM 33.

Note that before connecting to the communication system of a country, a mobile telephone equipped with an international roaming function generally receives a user specification of a target country. The mobile telephone then connects to the communication system of the specified country using an appropriate method (e.g. radio frequency band, modulation technique, audio coding technique, etc) based on the specification.

With the locality reception processing preformed in the above mobile telephone, only regions within the specified country are displayed as selection options on the region selection screen. Also, if the target country is included within a single time zone, the country itself may be regarded as having been specified as the locality, and the additional user operation to specify a region may be omitted.

Locality Notification Processing

Mobile telephone 2 transmits region information that expresses the telephone number identifying telephone 2 and the stored region code in a machine recognizable format to telephone 1 described in embodiment 1, in response to a predetermined user operation.

Examples of machine recognizable formats include the DTMF signal (see FIG. 8) and email (see FIG. 9) described in embodiment 1.

The user of mobile telephone 2 calls telephone 1 and has a DTMF signal transmitted to mobile telephone 2 through an audio channel by performing a predetermined operation during the call. If the user has pre-instructed mobile telephone 2 that a subsequent call is specifically for use in locality notification, mobile telephone 2 may be configured to transmit the DTMF signal as soon as the audio channel is established and disconnect the audio channel immediately after sending the signal.

Furthermore, region information can be transmitted/received by email if both mobile telephone 2 and telephone 1 are able to use email services.

In this case, the user of mobile telephone 2 designates the mail address specifying telephone 1 and has mobile telephone 2 transmit an email through a data channel.

### Embodiment 3

Described in embodiment 3 is a mobile telephone system constituted from a telephone network that notifies region information obtained as a result of the location registration of a mobile telephone to a telephone that originated a call addressed to the mobile telephone, and the telephone, which displays the local time at the other end of the connection based on the notified region information.

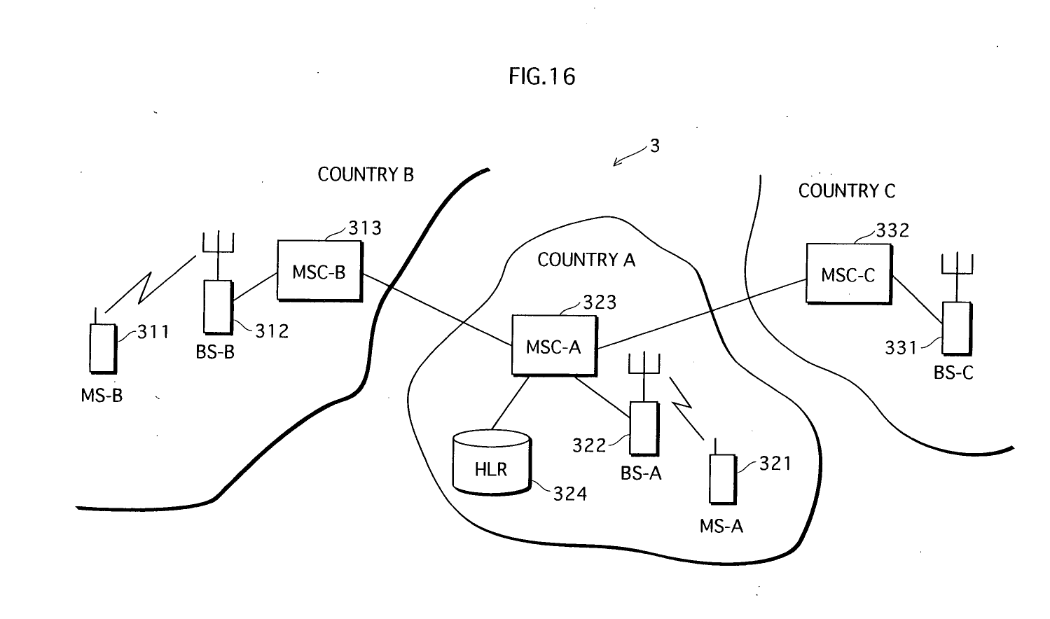

FIG. 16 is a schematic view showing the overall structure of the mobile telephone system. Mobile telephone system 3 includes, by way of example, the interconnected mobile telephone networks of countries A, B and C.

Country A's mobile telephone network includes a base station 322 BS-A)ᵣ a mobile switching center 323 (MSC-A), and a home location register 324 (HLR). Country B's mobile telephone network includes a base station 312 (BS-B) and a mobile switching center 313 (MSC-B). Country C's mobile telephone network includes a base station 331 (BS-C) and a mobile switching center 332 (MSC-C).

Mobile telephone 321 (MS-A), which is used in country A, displays the local time at the locality of callee's telephone(s), based on region information notified from country A's mobile telephone network. Mobile telephone 311 (MS-B), which was originally for use in country A, may also be used in countries B and C as a result of international roaming. In FIG. 16, MS-B is used in country B. Information relating the MS-B (includes region information obtained as a result of location registration) is managed by the HLR in country A.

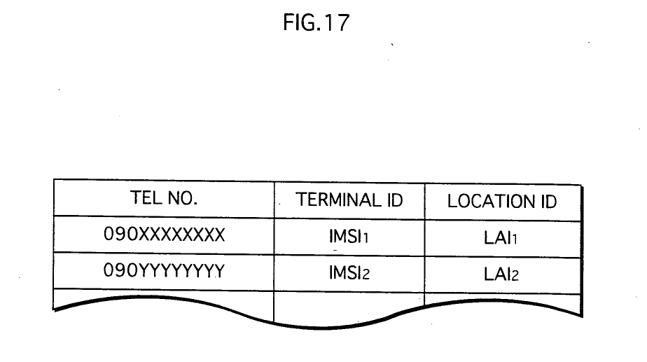

FIG. 17 shows an exemplary data structure and content of the principal information managed by the HLR. The HLR manages at least the terminal IDs, location IDs and telephone numbers of the individual mobile telephones. A terminal ID is information that uniquely identifies a mobile telephone internationally, an example of which is an IMSI (International Mobile Station Identity) used by UMTS (Universal Mobile Telecommunication System). A location ID is information that uniquely identifies the locality of a mobile telephone internationally, examples of which include an LAI (Location Area Identity) used by UMTS or any other information that expresses the locality with a precision enabling the time zone to be identified. A telephone number is the usual telephone number employed by a user.

Location registration is known technology in conventional mobile telephone systems. A very brief description is given here in relation to MS-B's location registration in country B.

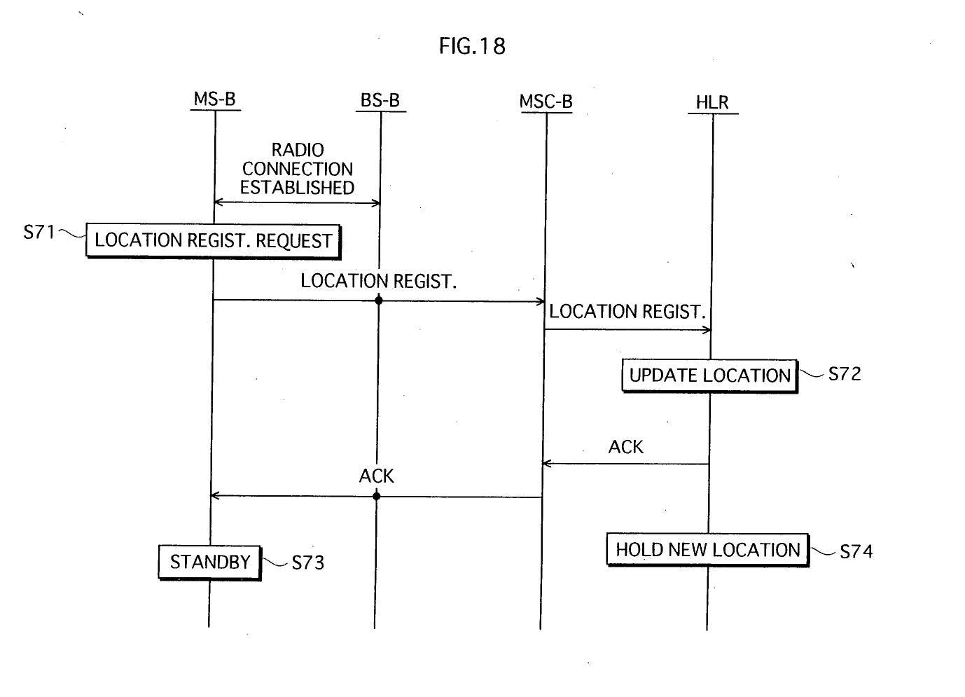

FIG. 18 is a flowchart showing the procedures involved in location registration. Once a radio connection is established between MS-B and BS-B, MS-B requests the HLR via BS-B and MSC-B for location registration (S71). On receipt of the request, the HLR finds out that MS-B is in the area of BS-B and updates the location ID of MS-B (S72). On receipt of an ACK reply showing that location registration has been completed, MS-B goes into standby (S73). The HLR holds the new location ID of MS-B (S74).

Conventionally, this location ID is referred to when originating a call addressed to MS-B, and used for placing a call to MS-B from a suitable base station (BS-B in the given example).

In mobile telephone system 3, country A's mobile telephone network notifies this location ID to the telephone that originated the call addressed to MS-B as region information relating to MS-B. The telephone displays the callee's local time based on the location ID notified by the telephone network. The telephone is realized using a similar configuration to telephone 1 described in embodiment 1 (see FIG. 1).

The telephone prestores correspondence information showing the association between location IDs and time zones.

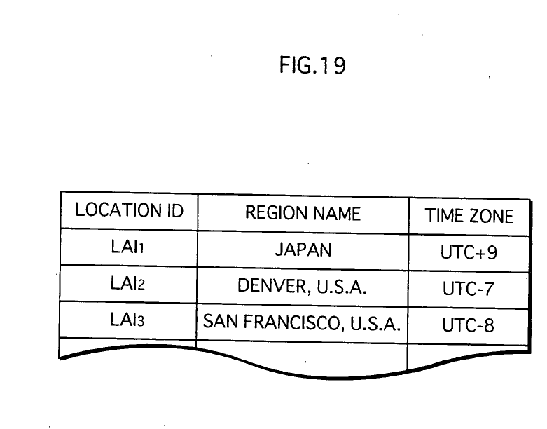

FIG. 19 shows an exemplary data structure and content of correspondence information. The correspondence information replaces the region codes stored in the time zone information table (see FIG. 4) described in embodiment 1 with the location IDs, and expresses time zones by the time difference with Coordinated Universal Time (UTC).

A detailed description of MS-A calling out to MS-B is given below.

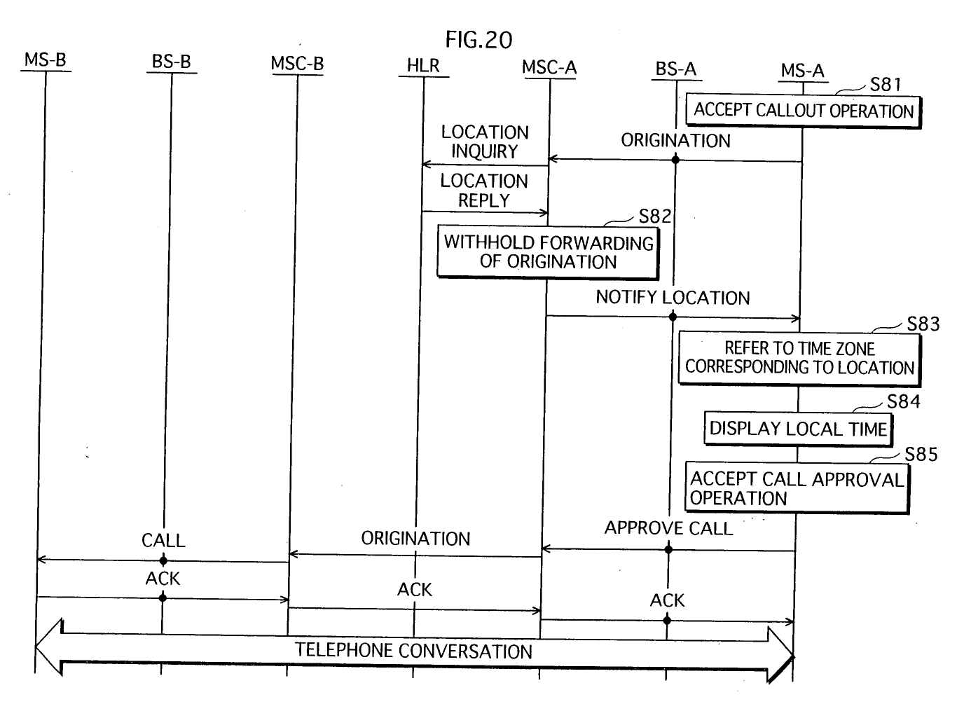

FIG. 20 is a flowchart showing this procedure. On receipt of a user operation to callout to MS-B (S81), MS-A transmits an origination message to MSC-A via BS-A showing a callout to MS-B. MSC-A makes an inquiry to the HLR about the location ID of MS-B, and receives a reply. Up to this point, the deciding of a base station to call MS-B is performed according to conventional operations. Then, departing from the prior art, MSC-A withholds transferring the origination message to the selected base station (S82), and notifies the location ID of MS-B to MS-A.

On acquiring the location ID, MS-A refers to the corresponding time zone, from the correspondence information (S83), calculates the callee's local time by adding the time difference between the acquired time zone and MS-A's time zone to the current time, and displays the calculated local time (S84). Here, MS-A's time zone is, for example, either set by the user or obtained when registering MS-A's location and stored in RAM (not depicted).

MS-A holds a computer program in ROM for performing this processing, and the control unit determines the time difference with the callee in accordance with the computer program, adds the determined time difference to the current time shown by the clock to derive the local time, and displays the derived local time on the display. For example, if the callee's time zone is “UTC−8 (San Francisco, USA)” and MS-A's time zone is stored as “UTC+9 (Japan)”, the control unit determines the time difference to be −17 hours and displays a time 17 hours prior to the current time as the local time.

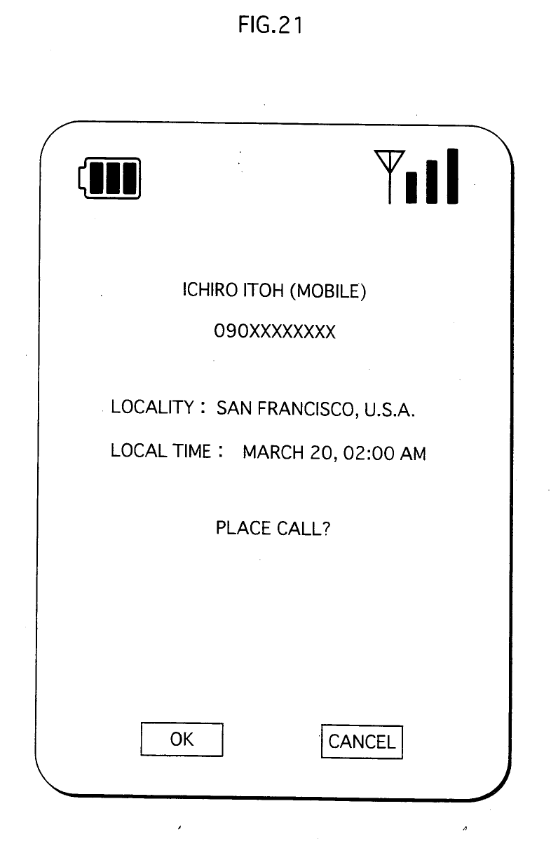

FIG. 21 shows an exemplary screen displaying local time. Shown here is an example in which the callee's name and telephone number and the name of the callee's locality are displayed together with the derived local time.

After the display of a screen such as this, MS-A receives a user operation approving or canceling the placement of a call. On receipt of a user operation approving the call, MS-A transmits a call approval message to MSC-A (S85). MSC-A transfers the held origination message to MSC-B after receiving the call approval message.

On receipt of the origination message, MSC-B places a call to MS-B via BS-B, as in the prior art. An ACK message is returned to BS-A when the user of MS-B answers, and a telephone call is carried out between the users of MS-A and MS-B.

Note that while not depicted in the drawings, MS-A transmits a disconnect message to MSC-A on receipt of a user operation canceling the call, and abandons the call to MS-B. On receipt of the disconnect message, MSC-A discards the held origination message.

Furthermore, a variation is also conceivable in which MSC-A transfers the held origination message to MSC-B if a predetermined time period elapses without receiving a disconnect message after the receipt of the origination message. This configuration is convenient for the user of MS-A, since a cancel operation need only be made if the user decides to abandon the call upon seeing the local time.

As described above, it is possible even with the mobile telephone system of embodiment 3 to check the callee's local time, the same as in embodiment 1, irrespective of whether or not information relating to the callee's locality is included in the callee's telephone number. Moreover, since the callee's most recent locality at the time of a callout is displayed in connection with the location registration of the callee's mobile telephone, it is possible to eliminate the time and effort taken up in managing the callee's locality manually, as well as the human errors and updating delays that can occur is this case.

Note that it is also conceivable to acquire the location IDs of individual callees, which are managed by an HLR, at any time in response to a user operation, rather than only at the callout time. The location IDs are held in a personal information table in association with individual callees, and are referred to in order to display the local time when placing a call to a callee, as in embodiment 1. With the personal information table in this case, the location IDs replace the region codes in the personal information table described in embodiment 1 (see FIG. 3).

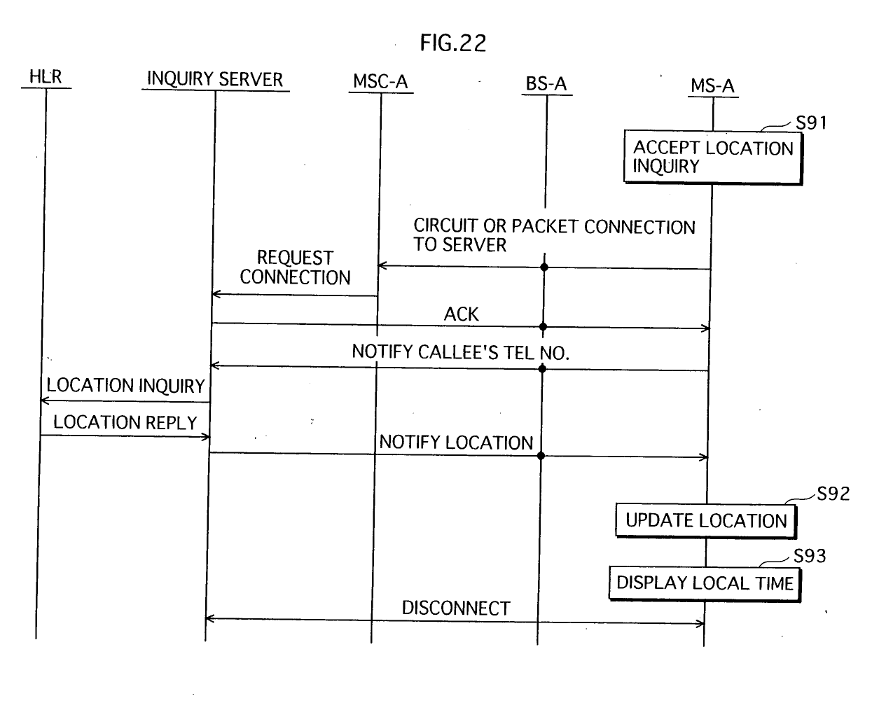

FIG. 22 is a flowchart showing a procedure for acquiring a callee's location ID in response to a user operation. In this example, MS-A inquires about the callee's location ID via an inquiry server.

On receipt of a user operation inquiring about a callee's location ID, MS-A requests MSC-A for connection to an inquiry server (S91). This inquire operation may, for example, be a predetermined operation performed by selecting a callee via a telephone directory screen (see FIG. 10). To connect to the inquiry server, MS-A is either circuit connected to a special code such as “1499”, for example, or packet connected to a specific address.

When an ACK showing connection to an inquiry server is returned, MS-A transmits the callee's telephone number to the inquiry server. If the inquiry operation is the predetermined operation performed via a telephone directory screen, MS-A transmits to the inquiry server the telephone number of the callee selected via the telephone directory screen. The inquiry server acquires the location ID corresponding to the telephone number from the HLR, and notifies the acquired location ID to MS-A. Communication between MS-A and the inquiry server may be carried out in accordance with WAP (Wireless Application Protocol), for example.

MS-A updates the location ID held in correspondence with the callee using the notified location ID (S92), and, as in the above step S84, derives the local time from the current time and the time difference with the callee and displays the derived local time (S93) and then disconnects from the inquiry server.

Further Variations

Note that while described above based on the preferred embodiments, the present invention is of course not limited to these embodiments. The following variations are also included in the present invention.

(1) The present invention may be a method that includes the steps described in the preferred embodiments, a machine-executable computer program for causing a computer to execute these steps, or a digital signal that expresses the computer program.

Also, the present invention may be a machine-readable recording medium having the computer program or digital signal recorded thereon, example of which include a flexible disk, a hard disk, a CD, an MO, a DVD, a BD, and a semi-conductor memory.

The present invention may alternatively be the computer program or digital signal transmitted via a network or the like, examples of which include a telecommunication line, a radio or cable communication line, and the Internet.

Also, the computer program or digital signal may be recorded on the recording medium for transportation or transported via the network or the like, and implemented in another independent computer system.

(2) It is possible to hold locality history information in association with the names of callees in personal information table 110, the locality history information showing one or more regions that have previously been associated with these names. Whenever personal information is updated by a user operation, the user selection of a region can be facilitated by giving priority to the display on the region selection screen (see FIG. 7) of the one or more regions shown by the locality history information.

(3) The present invention can also be applied within a single country having a plurality of time zones.

(4) Although one region is held in association with each callee in the preferred embodiments, a variation is conceivable in which a region is held for every telephone number of a callee.

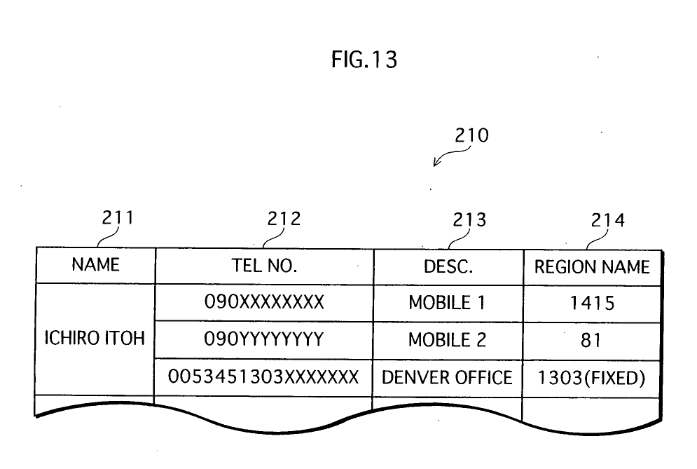

FIG. 13 shows an exemplary data structure and content of a personal information table 210 in the case of a different region code being held in association with each of a callee's one or more telephone numbers.

In personal information table 210, a name column 211 holds callees' names, a telephone number column 212 holds callees' telephone numbers, a description column 213 holds descriptions corresponding to the telephone numbers, and a region code column 214 holds region codes indicating a locality for each telephone number. One or more telephone numbers, descriptions and region codes are held per name.

Here, the region codes held in correspondence with telephone numbers that enables international roaming are updatable, while the region codes held in correspondence with all other telephone numbers are fixed.

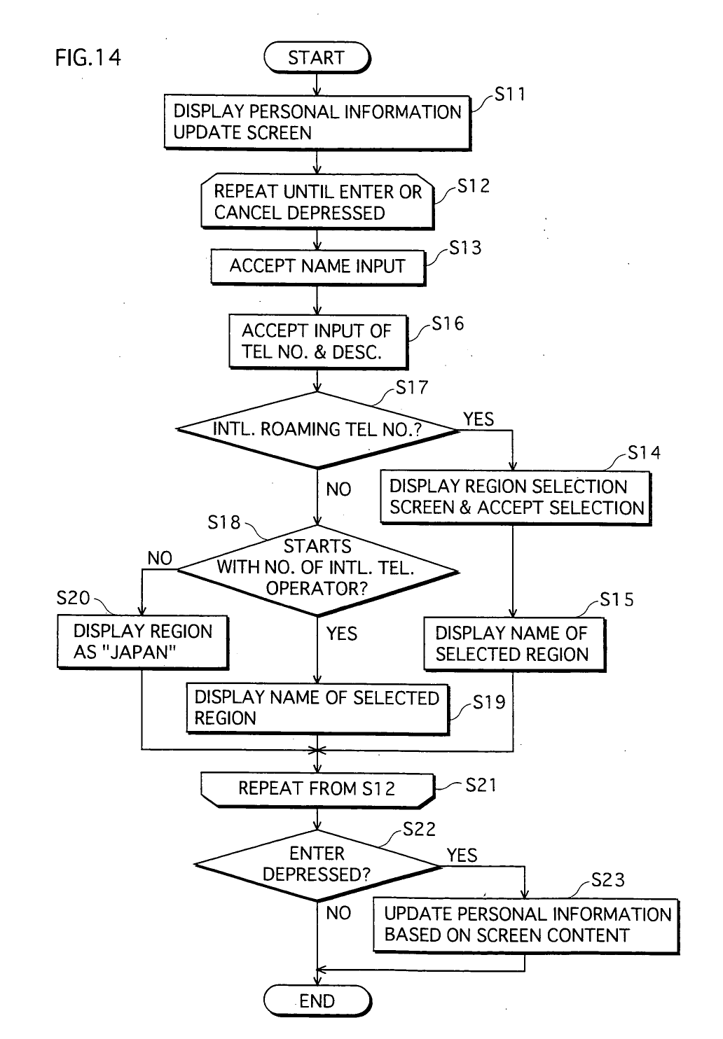

FIG. 14 is a flowchart showing personal information update processing adapted to personal information such as this. The processing here differs from the personal information update processing described in the preferred embodiments (see FIG. 5) in that a judgment is made for every telephone number as to whether international roaming is possible, and only if judged that international roaming is possible (S17=YES) is a locality selection accepted (S14-S15). If judged that international roaming is not possible (S17=NO), the locality fixedly deduced from the telephone number is decided upon, without accepting a locality selection (S18-S20).

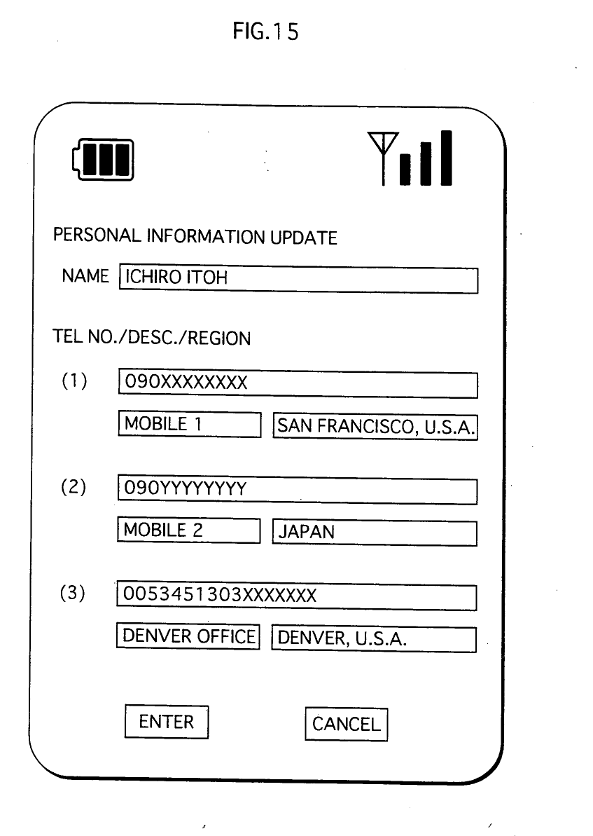

FIG. 15 shows a variation of the personal information update screen.

Since the regions can be managed for every telephone number, this configuration is ideal if the callee, for example, has two mobile telephones equipped with an international roaming function, one of which is used at the callee's travel destination, while the other is used at the callee's residence.

(5) A mobile telephone system that includes the telephone of embodiment 1 and the mobile telephone of embodiment 2 is also included in the present invention.

(6) While IMSIs were given as exemplary region information in embodiment 3, the object of the present invention can still be achieved if the time difference from UTC is used as region information. In this case, a time zone information table used in referring to time zones from IMSIs is not required, since the telephone network directly notifies the time difference of the callee's locality.

### INDUSTRIAL APPLICABILITY

A telephone pertaining to the present invention can be used, for example, as a telephone for correctly displaying the local time of the locality of a callee's mobile telephone equipped with an international roaming function.

1. A telephone for displaying a comprising:
an acquiring unit operable to acquire a telephone number of a callee region information relating to a locality of the callee;
a judging unit operable to judge whether the telephone number is a telephone number satisfying a predetermined condition that enables international roaming in a telephone network of a region in a different time zone;
a storage unit operable to store the telephone number, identification information identifying the callee of the telephone number, and the region information in association with each other, based on a user operation, if judged in the affirmative;
a calculating unit operable to calculate a local time of the locality shown by the region stored information, with reference to the storage unit, if a user operation selecting one of the telephone number and the identification information is performed; and
a display unit operable to display the local time.

2. (canceled)

3. The telephone of claim 1, wherein
the acquiring unit receives in an audible frequency band from a telephone of the callee a modulation signal representing the region information, and acquires the region information by decoding the received modulation signal.

4. The telephone of claim 1, wherein
the region information is transmitted from a telephone of the callee represented by an electronic mail, and
the acquiring unit acquires the region information by receiving from a telephone of the callee an electronic mail in which the region information is described.

5. The telephone of claim 1, wherein
the region information is recorded in a location register that manages a movement of the telephone of the callee in a telephone network, and
the acquiring unit acquires the region information by receiving the region information transmitted from the location register via the telephone network.

6. The telephone of claim 5, wherein
the acquiring unit acquires the region information as a reply to a callout to the telephone of the callee, and
the telephone further comprises:
a reception unit operable to receive a user operation after the display of the local time, the operation being one of approving and canceling a call; and
an instructing unit operable to instruct the telephone network to one of approve and cancel the call, upon receipt of the user operation.

7. (canceled)

8. (canceled)

9. (canceled)

10. (canceled)

11. (canceled)

12. (canceled)

13. A telephone system comprising a telephone network for managing a movement of a first telephone, and a second telephone for displaying a local time of a locality of the first telephone,
the telephone network including:
a location registration unit operable to record region information relating to the locality of the first telephone;
a reception unit operable to receive from the second telephone, specification information specifying the first telephone; and
a notifying unit operable to notify the region information to the second telephone, upon receipt of the specification information, and
the second telephone including:
an acquiring unit operable to acquire a telephone number of the first telephone;
a judging unit operable to judge whether the telephone number is a telephone number satisfying a predetermined condition that enables international roaming in a telephone network of a region in a different time zone;
a storage unit operable to store the telephone number, identification information identifying a callee of the telephone number, and the region information notified from the telephone network in association with each other, based on a user operation, if judged in the affirmative,
a calculating unit operable to calculate the local time of the locality shown by the stored region information, with reference to the storage unit, if a user operation selecting one of the telephone number and the identification information is presented; and
a display unit operable to display the local time.

14. The telephone system of claim 13, wherein
the reception unit receives the specification information from the second telephone as a callout request to the first telephone, and the telephone network further comprises:
a call unit operable to call the first telephone if a predetermined time period elapses without receiving an instruction from the second telephone after notifying the region information to the second telephone.

15. A method for having a telephone provided with a storage unit display a local time of a locality of a callee, comprising the steps of:
acquiring a telephone number of the callee region information relating to the locality of the callee;
judging whether the telephone number is a telephone number satisfying a predetermined condition that enables international roaming in a telephone network of a region in a different time zone;
storing the telephone number, identification information identifying the callee of the telephone number, and the region information in association with each other in the storage unit, based on a user operation, if judged in the affirmative;
calculating the local time of the locality shown by the stored region information, reference to the storage unit, if a user operation selecting one the telephone number and the identification information is performed; and
displaying the local time.

16. (canceled)

17. (canceled)

18. (canceled)

19. (canceled)

20. (canceled)

21. A method for displaying a local time of a locality of a first telephone performed in a telephone system that includes a second telephone provided with a storage unit and a telephone network for managing a movement of the first telephone, comprising the steps of:
recording, in the telephone network, region information relating to the locality of the first telephone;
receiving, in the telephone network, specification information specifying the first telephone from the second telephone;
notifying, in the telephone network, the region information to the second telephone, upon receipt of the specification information;
acquiring, in the second telephone, a telephone number of the first telephone;
judging whether the telephone number is a telephone number satisfying a predetermined condition that enables international roaming in a telephone network of a region in a different time zone;
storing, in the second telephone, the telephone number, identification information identifying a callee of the telephone number, and the region information notified from the telephone network in association with each other in the storage unit, based on a user operation, if judged in the affirmative;
calculating, in the second telephone, the local time of the locality shown by the stored region information, with reference to the storage unit, if a user operation selecting one of the telephone number and the identification information is performed; and
displaying, in the second telephone, the local time.

22. The method of claim 21, wherein
the specification information is received from the second telephone as a callout request to the first telephone, and
the method comprises the further step of:
calling, in the telephone network, the first telephone if predetermined time period elapses without receiving an instruction from the second telephone after notifying the region information to the second telephone.

23. A computer program for having a telephone provided with a storage unit, display a local time of a callee comprising the steps of:
acquiring a telephone number of the callee and region information relating to a locality of the callee;
judging whether the telephone number is a telephone number satisfying a predetermined condition that enables international roaming in a telephone network of a region in a different time zone;
storing the telephone number, identification information identifying the callee of the telephone number, and the region information relating to the locality of the callee in association with each other in the storage unit, based on a user operation, if judged in the affirmative;
calculating the local time of the locality shown by the stored region information, with reference to the storage unit, if a user operation selecting one of the telephone number and the identification information is performed; and
displaying the local time.

24. (canceled)

25. (canceled)

26. (canceled)

27. (canceled)

28. (canceled)

29. A computer program that causes a telephone system to execute display processing for displaying a local time of a locality of a first telephone, the telephone system including a second telephone provided with a storage unit and a telephone network for managing a movement of the first telephone, the display processing comprising the steps of:
recording, in the telephone network, region information relating to the locality of the first telephone;
receiving, in the telephone network, specification information specifying the first telephone from the second telephone;
notifying, in the telephone network, the region information to the second telephone, upon receipt of the specification information;
acquiring, in the second telephone, a telephone number of the first telephone;
judging whether the telephone number is a telephone number satisfying a predetermined condition that enables international roaming in a telephone network of a region in a different time zone;
storing, in the second telephone, the telephone number, identification information identifying a callee of the telephone number, and the region information notified from the telephone network in association with each other in the storage unit, based on a user operation, if judged in the affirmative;
calculating, in the second telephone, the local time of the locality shown by the stored region information, with reference to the storage unit, if a user operation selecting one of the telephone number and the identification information is performed; and
displaying, in the second telephone, the local time.

30. The computer program of claim 29, wherein
the specification information is received from the second telephone as a callout request to the first telephone, and
the display processing comprises the further step of:
calling, in the telephone network, the first telephone if predetermined time period elapses without receiving an instruction from the second telephone after notifying the region information to the second telephone.
